(19) United States
(12) Patent Application Publication
(10) Pub. No.: US 2007/0193522 A1
(43) Pub. Date: Aug. 23, 2007

(54) Collapsible pet bed with attachable storage

(76) Inventor: Lori Greschler, Millbury, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/359,825

(22) Filed: Feb. 21, 2006

(51) Int. Cl. A01K 29/00

(52) U.S. Cl. 119/28.5

(57) ABSTRACT

A pet bed is formed of sides having a frame and a flexible material within the frame. The bed can be folded for transport. The bed includes a bag attachable to the side for holding toys and supplies. The bag can be removed when the bed is folded and/or for carrying toys and supplies.

### BACKGROUND OF THE INVENTION

1. Field of the Invention

The present invention relates to pet beds, crates and carriers. More particularly, it relates to a pet bed or carrier which is collapsible and which includes a removable storage space.

2. Discussion of Related Art

Pet care has become a burgeoning industry. The number of pets in the United States has increased dramatically. This has caused a corresponding increase in the number and kinds of products available for pets. One of the major increases has been in the area of toys for dogs. As owners have become busier, they strive to make the limited time available with their dog more enjoyable, for both them and the dog. One way to do so is through the use of toys. As the number of toys increases, the capacity to store the toys becomes more complicated. The toys tend to get spread around the house by the dog. There are no simple storage mechanisms.

Additionally, the opportunities for outdoor activities with dogs have become limited. Many communities have “leash laws” which prevent the dog from being off the leash in public. Many owners live in urban or suburban areas which lack open space for a dog. These owners must travel distances, either walking or in a vehicle, to a park or other area to allow greater activity for the dog. When at such open areas, it is useful to have the dog's toys and other supplies. Therefore, a need exists for a mechanism for transporting toys and supplies. However, this is difficult when the toys are disorganized within the house.

Furthermore, when traveling with a dog, even for a day, it is useful to provide an area comfortable for and familiar to the dog. Carriers and crates can perform this function. However, these are typically bulky and heavy and not easily transported. Collapsible carriers and crates become less cumbersome, but are often complicated to set up. The carrier or crate simply becomes another item which must be carried, along with the dog's toys and supplies.

### SUMMARY OF THE INVENTION

The present invention overcomes many deficiencies in existing pet products by providing a collapsible pet bed with a detachable toy or storage bag. According to one aspect of the invention, a bed is formed from four flexible sides vertical sides hinged together. At least one of the sides includes an opening to allow the pet to enter. Flexible top and bottom structures may be attached to the sides to create a space for the pet. According to one aspect of the invention, the sides are flexibly attached together to allow the structure to be folded for carrying. According to another aspect of the invention, the bed includes straps along the bottom for attaching to the seat belt system of a vehicle.

According to another aspect of the invention, the sides of the bed are formed from fabric or other flexible material. Each side includes a wire loop frame within a casing of the outer edge of the fabric. According to aspects of the invention, the casing may be a closed loop or may be open to allow removal of the wire loop frame.

According to another aspect of the invention, a toy or storage bag is attachable to one side of the bed. The toy bag provides a convenient location to store the pet's toys. The bag can be detached to take the toys to other locations. According to another aspect of the invention, the bag includes compartments for holding toys or supplies. According to another aspect of the invention, the bag includes one or more handles or straps which are foldable within the bag. According to another aspect of the invention, the storage bag is includes zippers along the sides so that the bag can be opened flat. According to another aspect of the invention, the bag includes a hook for hanging the bag.

### BRIEF DESCRIPTION OF THE DRAWINGS

FIG. 1 is a perspective view of a pet bed according to an embodiment of the present invention.

FIG. 2 is a perspective view of an attachable toy bag according to an embodiment of the present invention.

FIG. 3 is a partial cross sectional view of a mechanism for attaching the bag to the pet bed according to another embodiment of the invention.

FIGS. 4A and 4B are respective views of an attachable bag according to another embodiment of the present invention.

### DETAILED DESCRIPTION

The present invention provides a structure for providing comfort and easy transportability for a dog or other pet and his toys and supplies. The structure includes a bed 1 having an attachable bag 100 as illustrated in FIG. 1. The bed may be constructed in any known manner. According to a preferred embodiment of the invention, the bed is formed of a flexible material with a frame. This allows the bed to be foldable or collapsible. However, other types of beds could also be used in connection with the attachable bag of the present invention. The bed may be a hard sided carrier of known construction, whether or not foldable. It may be a cage or similar structure formed from wires.

According to a preferred embodiment, illustrated in FIG. 1, the bed 1 has four sides 10, 20, 30, 40 (one side 40 is not visible in FIG. 1). Of course, the bed 1 can be formed of more or fewer sides depending upon the desired shape of the bed. Each of the sides includes a material 13, 23 of substantially rectangular shape within a frame. The material may be of various constructions. It may include natural or artificial fibers woven into a fabric. It may include a mesh. It may include a preformed material. Furthermore, different sides of the bed, or parts of each side may be formed of different materials.

The frame is formed of a wire loop having sufficient rigidity to hold the material 13, 23 substantially flat. The frame for each side is held within a casing 11, 21 attached to the outer edges of the material 13, 23. The casing, as with the material, can have different constructions. The casing may be formed as a closed tube attached to the material so that the wire loop is held permanently in place. The casing may be formed as a tube with an opening along one part of the side so that wire can be fed into the casing to form the wire loop, but remain removable. The casing may also be formed as an open flap along the edge of the material of the side so that a wire loop can be easily placed within and removed from the flap.

The four sides 10, 20, 30, 40 are attached at their adjacent edges to form an supportable structure. As illustrated in FIG. 1, a piece of material 15 may be attached between the casing 11, 21 along the edge of adjacent sides. Alternatively, the casings themselves may be attached together. The mechanisms for attaching the sides together may be permanent, temporary, or a combination. The sides may be sewn together to form a permanent rectangle, when viewed from above. Alternatively, one or more of the edges may be detachable. The edges may include strips of Velcro®, so that the edges may be attached or detached. Other mechanism, such as snaps, zippers, clips or ties may be used for connecting edges of two adjacent sides.

According to a preferred embodiment, the bed 1 includes a bottom 50 and top 60 within the areas formed by the sides. The bottom 50 and top 60 are formed of material similar to the sides. As with the adjacent edges of the sides, they may be permanently attached to corresponding edges of the sides or may be detachable from the edges. At least one side 10, includes an opening 12 within the material. The opening 12 allows the dog or other pet to enter or leave the bed.

The structure of the bed 1 as described above allows the bed to be collapsed or folded so that it can be transported. The exact construction of the bed will determine the process for folding it. For an embodiment having permanently attached sides, the sides may be folded together so that two adjacent sides 10, 20 (for example) face each other. If the sides all have the same length, the structure may be folded again, so that all four sides are stacked together. If one or more edges of the sides are detachable, the sides may be easily stacked or folded in a zig-zag format.

According to another embodiment, a plurality of loops 271, 272 are attached to corners or edges of the bed. A seat belt can pass through the loops 271, 272 to hold the bed in place for travel in a vehicle. If loops 271, 272 are positioned on each of the four corners of the bed, the bed can be positioned in any direction in the vehicle and accommodate the seat belt.

According to an embodiment of the invention, a bag 100 is attachable to one side 20 of the bed 1. An embodiment of the bag 100 is illustrated in FIG. 2. The bag 100 is formed to have an opening 110 at the top. The opening 110 may include a zipper or other structure (not shown) for closing the bag. Handles 120, 121 are attached to interior 111 sides of the bag 100. Having the handles 120, 121 attached to the interior 111 of the bag 100 allows them to be easily positioned within the bag. Thus, the handles can be positioned out of view when the bag is attached to the bed. The handles can be removed from the interior of the bag for ease in transporting the bag. Although two attached handles are shown, other structures could be used for carrying the bag. A single strap may be attached to and similarly stored in the bag. Detachable handles or straps may be used on the interior or exterior of the bag.

As illustrated by the dashed lines in FIG. 2, the bag may include compartments 141, 142 for storing toys or supplies. The compartments 141, 142 permit increased organization in using the bag.

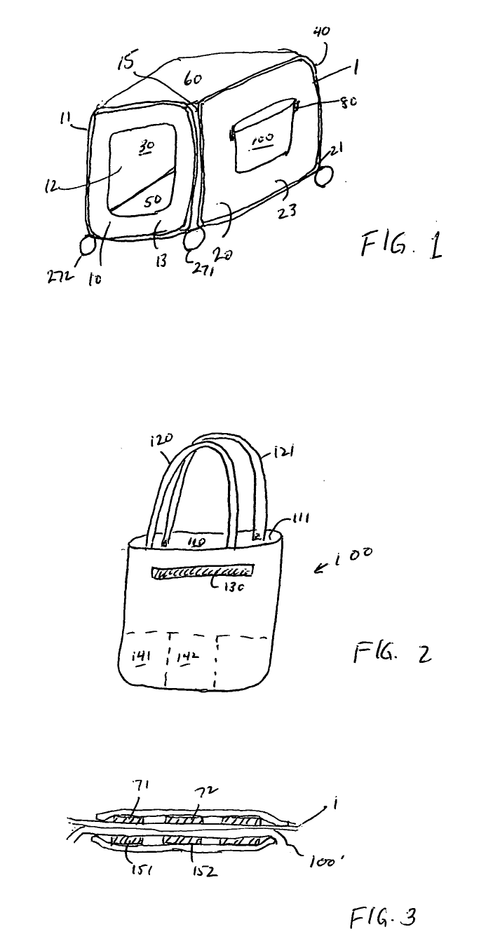

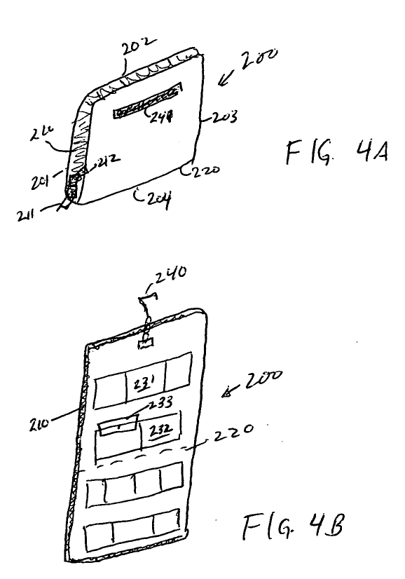

According to a preferred embodiment, a strip of Velcro® 130 is positioned along a top edge of the bag. A corresponding strip of Velcro® 80 is attached to one side 20 of the bed 1. The bag 100 can be attached to the bed to hold toys or other supplies. It provides a simple container for storing such items. When traveling, the bag 100 can be removed from the bed 1 to carry the toys or supplies to the desired location. The bed can also be collapsed and carried, if desired. Other mechanisms can be used to attach the bag 100 to the side 20 of the bed 1. According to another embodiment, one or more magnets are used to attach the bag 100 to the bed 1. FIG. 3 is a cross sectional view looking from the top of the bed 1 and bag 100′ according to this embodiment. A plurality of magnets 71, 72 are sewn into the fabric on a side 20 of the bed 1. A similar plurality of magnets 151, 152 are sewn into the fabric on one side of the bag 100′. When the bag 100′ is positioned near the side of the bed 1, the magnets attract so that the bag is held to the bed. Alternatively, magnetizable metal may be used instead of one set of magnets, either in the bag or the bed. The magnets in the corresponding part will still attract and hold the bag in place. Similar structures can be used with hard cases. For metal crates, magnets can be used just in the bag to attach directly to the crate. Buttons, zippers, snaps, hooks, etc. can also be included on both the bag and the side of the bed for attachment.

FIGS. 4A and 4B illustrate a second embodiment of a storage bag 200. FIG. 4A illustrates the bag in the closed position and FIG. 4B illustrates the bag in the open position. As illustrated, the bag 200 in this embodiment has a zipper 210 on three sides 201, 202, 203. The zipper may have multiple pulls 211, 212 or a single pull (not shown) can be used. The fourth side 204 of the bag 200, when closed, is formed by a fold 220 of the bag. When opened, the bag 200 lies or hangs flat, without a fold. The bag 200 includes a plurality of compartments or pockets 231, 232 for holding toys or supplies. The each pocket 231, 232 may be open at the top or may have a flap 233 to close the pocket. According to an embodiment of the invention, the top of all pockets 231, 232 face the same direction. The bag 200 is folded in half and zipped closed (FIG. 4A) for storage or travel. As with other embodiments, the bag can include a structure attached to one side for attaching the bag to the bed, when in the closed position. When opened (FIG. 4B), the bag 200 is flat. It can be laid on a surface or hung up, using one or more hooks 240 attached to the top. In this manner, the toys or supplies in the pockets are easily accessible.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A pet bed comprising:
at least four vertical sides connected together, at least one side having an opening for the pet to enter the space between the connected sides, wherein the at least four vertical sides can be folded at locations where they are connected together so that substantially no space is between the sides; and
a first releasable connector positioned along one of the at least four sides, the first releasable connector allowing an item attached thereto to hand from the one of the at least four sides.

2. The pet bed according to claim 1, wherein the first releasable connector includes a piece of Velcro.

3. The pet bed according to claim 1, wherein the first releasable connector includes at least one magnet.

4. The pet bed according to claim 1, further comprising:
a storage bag, wherein the storage bag includes a second releasable connector positioned along one side of the storage bag, and wherein the second releasable connector is attachable to the first releasable connector.

5. The pet bed according to claim 4, wherein the storage bag includes a plurality of compartments formed within the storage bag.

6. The pet bed according to claim 4, wherein the storage bag includes at least one handle which can be folded into the bag.

7. The pet bed according to claim 4, wherein the storage bag includes a zipper along three sides allowing the bag to be closed when in a folded position.

8. (canceled)

9. The pet bed according to claim 1, further comprising at least one loop attached to at least one of the vertical sides for coupling the pet bed to a restraint system of a vehicle.

10. A storage bag for pet supplies comprising:
a bag portion having at least two sides;
an releasable connector attached to one of the at least two sides for connecting to a side of a pet container.

11. The storage bag according to claim 10, wherein the releasable connector includes a piece of Velcro.

12. The storage bag according to claim 10, wherein the releasable connector includes at least one magnet.

13. The storage bag according to claim 10, further comprising:
a zipper positioned for releasably coupling the at least two sides to form an enclosed area between the at least two sides.

14. The storage bag according to claim 10, further comprising a plurality of compartments between the at least two sides.

15. The storage bag according to claim 10, further comprising a hook attached to one of the at least two sides for hanging the storage bag.
